(19) United States
(12) Patent Application Publication
(10) Pub. No.: US 2009/0268123 A1
(43) Pub. Date: Oct. 29, 2009

(54) Flat Display Module

(75) Inventor: Ke-Feng Lin, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/110,204

(22) Filed: Apr. 25, 2008

(51) Int. Cl. G02F 1/1333

(52) U.S. Cl. 349/58

(57) ABSTRACT

A flat display module comprises a holding housing, a backlight module, a liquid module and a signal transmitting unit. The holding housing has a plurality of rims which collectively define a receiving room. The backlight module is received in the receiving room. The liquid crystal display module also is received in the receiving room of the holding housing and adjoins one side of the backlight module. The signal transmitting unit also is received in the receiving room and located on the other side of the backlight module, a side of the signal transmitting unit is bent to form a fixing portion engaging an outer side of one of the rims so that the signal transmitting unit is secured on the holding housing.

### BACKGROUND OF THE INVENTION

1. Field of the Invention

This present invention relates to a flat display module, and more specifically to a fixing structure of a signal transmitting unit of the flat display module.

2. The Related Art

Liquid crystal display (LCD) devices are widely applied to information products such as personal desktop computers, note book computers, personal digital assistants (PDA), mobile phones, etc., to display pictures and video, owing to the characteristics of light weight, low power consumption, and little radiation pollution. The LCD device is poised to replace a cathode ray tube (CRT) monitor and a conventional TV.

A conventional flat display module used in an LCD device includes an LCD module, a backlight module, a plastic holding housing and a signal transmitting module. The signal transmitting module is a flexible printed circuit board (FPCB). The plastic holding housing is used to receive the LCD module and the backlight module. A lower side of the backlight module connects with the LCD module, and the signal transmitting module is arranged on an upper side of the backlight module and pasted in a side of the plastic holding housing.

Because the LCD module and the backlight module are located in the plastic holding housing, the space of the plastic holding housing for fixing the signal transmitting module is limited, so the signal transmitting module fixed in the plastic holding housing affects signal transmission between the LCD module and the signal transmitting module.

### SUMMARY OF THE INVENTION

An object of the invention is to provide a flat display module including a holding housing, a backlight module, a liquid module and a signal transmitting unit. The holding housing has a plurality of rims which collectively define a receiving room. The backlight module is received in the receiving room. The liquid crystal display module also is received in the receiving room of the holding housing and adjoins one side of the backlight module. The signal transmitting unit also is received in the receiving room and located on the other side of the backlight module, a side of the signal transmitting unit is bent to form a fixing portion engaging an outer side of one of the rims so that the signal transmitting unit is secured on the holding housing.

As described above, the fixing portion bent from the side of the signal transmitting unit is fixed in the outer side of one of the rims, so the signal transmitting unit is fixed in holding housing tightly. Furthermore, a receiving groove is opened in the outer side of the rim for fixing the fixing portion therein, thus the fixing portion does not project out of the side of the holding housing to make the assembly process of the flat display module conveniently and reduce the volume of the flat display module.

### BRIEF DESCRIPTION OF THE DRAWINGS

The invention, together with its objects and the advantages thereof may be best understood by reference to the following description taken in conjunction with the accompanying drawings, in which:

FIG. 1 is an exploded perspective view of a flat display module according to the present invention;

FIG. 2 is a perspective view of a signal transmitting unit of the flat display module of FIG. 1; and

FIG. 3 is a perspective view of the flat display module of FIG. 2 viewed from another direction.

### DETAILED DESCRIPTION OF THE PREFERRED EMBODIMENT

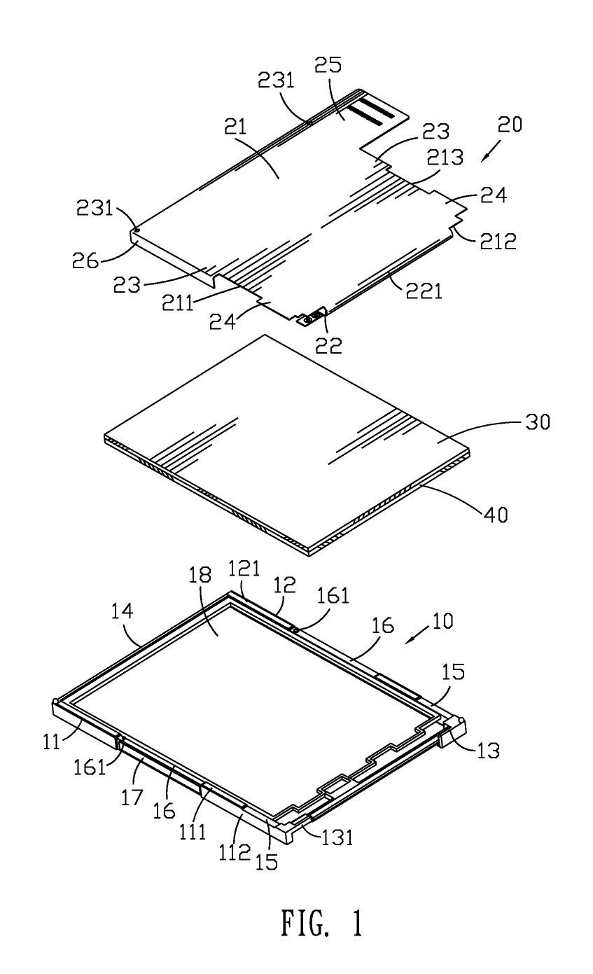

Referring to FIGS. 1-3, a flat display module 1 according to the invention is shown. The flat display module 1 includes a holding housing 10, a signal transmitting unit 20, a backlight module 30 and a liquid crystal display (LCD) module 40. The holding housing 10 of a rectangular shape has a first rim 11, a second rim 12, a third rim 13 and a fourth rim 14, all of which collectively constitute and define a receiving room 18 shown to be a rectangular shape. The first rim 11 is opposite to the second rim 12 and similarly, the third rim 13 is opposite to the fourth rim 14. The first rim 11 has a first top surface 111 and a first flank 112. The second rim 12 has a second top surface 121. The third rim 13 has a third flank 131. The first top surface 111 of the first rim 11 and the second top surface 121 of the second rim 12 respectively define a first groove 15 at portions near the third rim 13. The middle of the first top surface 111 and the middle of the second top surface 121 define a second groove 16 respectively. A projecting column 161 protrudes from the bottom of the second groove 16 and is near to the fourth rim 14. The first flank 112 sinks inward to form a receiving groove 17 which connects with the corresponding second groove 16. The length of the receiving groove 17 equals to the length of the second groove 16.

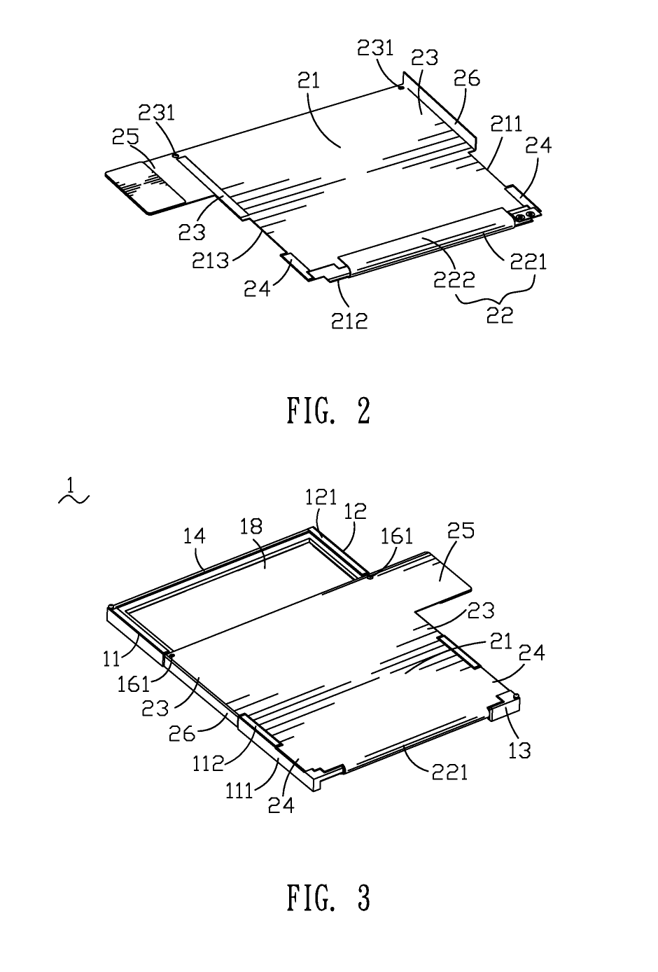

Please referring to FIGS. 1 and 2, the signal transmitting unit 20 may be a printed circuit board (PCB), a flexible printed circuit board (FPCB), or a flexible flat cable (FFC) or the like known in the art. In this embodiment, the signal transmitting unit 20 is an FPCB. The signal transmitting unit 20 has a base 21. The base 21 has a first side 211, a third side 213 opposite to the first side 211 and a second side 212 connecting the first side 211 and the third side 213. The second side 212 of the base 21 curves downward and then extends inward to form a clipping portion 22. The clipping portion 22 has a curving portion 221 and a connecting portion 222. The curving portion 221 connects with the second side 212, and the connecting portion 222 extends inward from a free end of the curving portion 221 and is parallel with the base 21. A rear end of the first side 211 and a rear end of the third side 213 extend outward to form a first clicking portion 23 respectively. A front end of the first side 211 and a front end of the third side 213 respectively extend outward to form a second clicking portion 24 near the second side 212. Two clipping holes 231 are defined symmetrically in rear ends of the first clicking portions 23. One of the first clicking portions 23 near the third side 213 extends outward to form a contacting portion 25 which connects to electronic parts (not shown). The other first clicking portion 23 near the first side 211 extends downward vertically to form a fixing portion 26.

In FIGS. 1 to 3, the receiving room 18 of the holding housing 10 is used to receive the LCD module 40 and the backlight module 30 which is used to provide brightness for the LCD module 40. A bottom side of the backlight module 30 adjoins the LCD module 40, while the signal transmitting unit 20 is arranged on a top side of the backlight module 30. The first clicking portions 23 are arranged in the second grooves 16 of the holding housing 10 and received in the bottoms of the second grooves 16 by adhesive. The fixing holes 231 engage with the projecting columns 161. The second clicking portions 24 are arranged in the first grooves 15 and received in the bottoms of the first grooves 15 by adhesive. The curving portion 221 covers the third flank 131. The connecting portion 222 is attached on the bottom of the holding housing 10. The fixing portion 26 is arranged in the receiving groove 17, and received in the bottom of the receiving groove 17. The method arranging the fixing portion 26 in the receiving groove 17 is not limited to the above way.

As described above, in the present invention, the fixing portion 26 is fixed in the receiving groove 17, so that the signal transmitting unit 20 is fixed in holding housing 10 tightly, and for the design of the receiving groove 17 in the holding housing 10, the fixing portion 26 does not project out from the side of the holding housing 10 to make the following assembly process of the flat display module 1 easier and to reduce the volume of the flat display module 1.

An embodiment of the present invention has been discussed in detail However, this embodiment is merely a specific example for clarifying the technical contents of the present invention and the present invention is not to be construed in a restricted sense as limited to this specific example. Thus, the spirit and scope of the present invention are limited only by the appended claims.

What is claimed is:

1. A flat display module, comprising:
a holding housing having a plurality of rims which collectively define a receiving room;
a backlight module received in the receiving room;
a liquid crystal display module also received in the receiving room of the holding housing and adjoining one side of the backlight module; and
a signal transmitting unit also received in the receiving room and located on the other side of the backlight module, a side of the signal transmitting unit bent to form a fixing portion engaging an outer side of one of the rims so that the signal transmitting unit is secured on the holding housing.

2. The flat display module as set forth in claim 1, wherein the rims includes a first rim, a second rim opposite to the first rim, a third rim and a fourth rim opposite to each other, the four rims defining the receiving room, the first rim having a first top surface and a first flank, and the second rim having a second top surface.

3. The flat display module as set forth in claim 2, wherein the signal transmitting unit has a base, which contains a first side, a third side opposite the first side and a second side connecting the first side and the third side together, the first side and the third side extending oppositely to form a first clicking portion respectively, the first clicking portion near the first side bending downward to form the fixing portion fixed in the first flank of the first rim.

4. The flat display module as set forth in claim 3, wherein the first top surface and the second top surface define a second groove respectively for receiving the corresponding first clicking portion, and the first flank sinks inward to form a receiving groove which connects with the second groove in the first rim for receiving the fixing portion.

5. The flat display module as set forth in claim 4, wherein two projecting columns are defined in the bottom of the second grooves, while the first clicking portions define two fixing holes engaging the corresponding projecting columns.

6. The flat display module as set forth in claim 3, wherein the first clicking portion near the third side extends outward to form a contacting portion.

7. The flat display module as set forth in claim 3, wherein the first side and the third side extend opposite to form a second clicking portion apart from the first clicking portion respectively, and the first top surface and the second top surface define a first groove apart from the second groove respectively for receiving the corresponding second clicking portion.

8. The flat display module as set forth in claim 3, wherein the second side of the base curves downward and then extends inward to form a clipping portion for clipping the holding housing.
